(19) United States
(12) Patent Application Publication
(10) Pub. No.: US 2026/0234988 A1
(43) Pub. Date: Aug. 13, 2026

(54) SECTIONAL DOOR WITH DE-BRIDGED EXTRUSIONS FOR IMPROVED THERMAL PERFORMANCE

(71) Applicant: Clopay Corporation, Mason, OH (US)

(72) Inventor: John K. McGee, Fort Loramie, OH (US)

(73) Assignee: Clopay Corporation, Mason, OH (US)

(21) Appl. No.: 19/474,784

(22) PCT Filed: May 9, 2023
(86) PCT No.: PCT/US2023/021461

§ 371 Date: Oct. 13, 2025

(51) Int. Cl. E06B 3/48; E06B 3/16; E06B 3/263; E06B 3/267

(52) U.S. Cl. CPC E06B 3/485; E06B 3/163; E06B 3/26301; E06B 3/267

(57) ABSTRACT

In example implementations, a de-bridged extrusion for a panel of a sectional door and a method for fabricating the same are provided. The de-bridged extrusion includes a first side, a second side, and an insulation essentially filling a volume between the first side and the second side, wherein the first side and the second side are derived from a single piece of extrusion and a portion of the single piece of extrusion is removed to create a gap between the first side and the second side.

### BACKGROUND

Doors can be used for a variety of applications. For example, doors can be used as in residential locations or doors for bays and entrances to warehouses in commercial locations. Some doors may include sectional doors. One type of sectional door may be garage doors.

Sectional doors may be made from a plurality of individual sections that are mechanically coupled together. The size and number of sections may be determined based on a size of the opening of the garage or any other type of location with an opening.

Sectional doors, such as garage doors, comprise the envelope of the building and factor into energy efficiency performance of the building. However, as designs of sectional doors improve, sectional doors provide improved energy efficiencies. Sectional door designs that are full-view, or comprising multiple glazing sections within a stile framework provide a challenge for energy efficiency performance of the building, especially when multiple doors are utilized. However, the natural light and modern look are popular for doors, but also as movable walls for commercial and residential buildings so improved energy efficiencies are desired.

### BRIEF DESCRIPTION OF THE DRAWINGS

FIG. 1 illustrates a block diagram of an example sectional door with de-bridged extrusions of the present disclosure;

FIG. 2 illustrates a close up view of an example panel with connected de-bridged extrusions of the present disclosure;

FIG. 3 illustrates a cross-sectional view of an example end stile de-bridged extrusion of the present disclosure;

FIG. 4 illustrates a side view of the example end stile de-bridged extrusion of the present disclosure;

FIG. 5 illustrates a cross-sectional view of an example center stile de-bridged extrusion of the present disclosure;

FIG. 6 illustrates a cross-sectional view of an example bottom rail de-bridged extrusion of the present disclosure;

FIG. 7 illustrates a cross-sectional view of an example top rail de-bridged extrusion of the present disclosure; and

FIG. 8 illustrates a flow chart for a method of fabricating a de-bridged extrusion for a panel of a sectional door of the present disclosure.

### DETAILED DESCRIPTION

Examples described herein provide examples of a sectional door with de-bridged extrusions for improved thermal performance and methods for fabricating the same. As discussed above, doors can be used for a variety of different applications. Some doors may be sectional doors, such as those used as garage doors.

Sectional doors, such as garage doors, comprise the envelope of the building and factor into energy efficiency performance of the building. However, as designs of sectional doors improve, sectional doors provide improved energy efficiencies. Sectional door designs that are full-view, or comprising multiple glazing sections within a stile framework provide a challenge for energy efficiency performance of the building, especially when multiple doors are utilized. The natural light and modern look are popular for doors, but also as movable walls for commercial and residential buildings. For example, sectional doors can be used as a movable wall that can be selectively opened to create an indoor-outdoor open space and selectively closed to create a secured building envelope.

As sectional doors are factored into the energy efficiency, the sectional door should provide good thermal performance. Some sectional doors are fabricated with metal frames. Even though the metal frames may be insulated, metal is a good conductor of energy (e.g., heat). As a result, heat may pass from the surface of the door to the indoor surface of the door, or vice versa, easily through the frame material (e.g., metal) itself regardless of if the frame is insulated. In other words, the frame material reduces energy performance of the overhead door.

The present disclosure provides a sectional door with de-bridged frame elements that improve the thermal performance of the sectional door. For example, thermal performance, such as U-factor, can be greatly improved via the de-bridged extrusions.

In some examples of frame elements, a metal extrusion can be formed for end stiles, center stiles, top rails, and bottom rails that are assembled to form the panels of the sectional door. The interior volume of the extrusions can be filled with insulation, such as an expanding polymeric insulation. After the interior volume of the extrusions are filled with insulation, a portion of the extrusion can be removed to create a gap in the extrusion and form two separate sides of the de-bridged extrusion. Thus, due to the gap formed between the two sides of the extrusion, heat or energy is prevented from conducting from one side of the panel to the other via the extrusion. The gap eliminates the extrusion from acting against the thermal barrier performance of the insulation.

In addition, the location of the gap or the portion that is removed from the extrusion may be selected to maximize the aesthetic look of the sectional door or to prevent infiltration of elements such as precipitation, wind, sunlight. For example, the placement of a portion to be removed is selected such that the gap is hidden when the panel is assembled. As a result, the gap of the extrusions may not be noticeable.

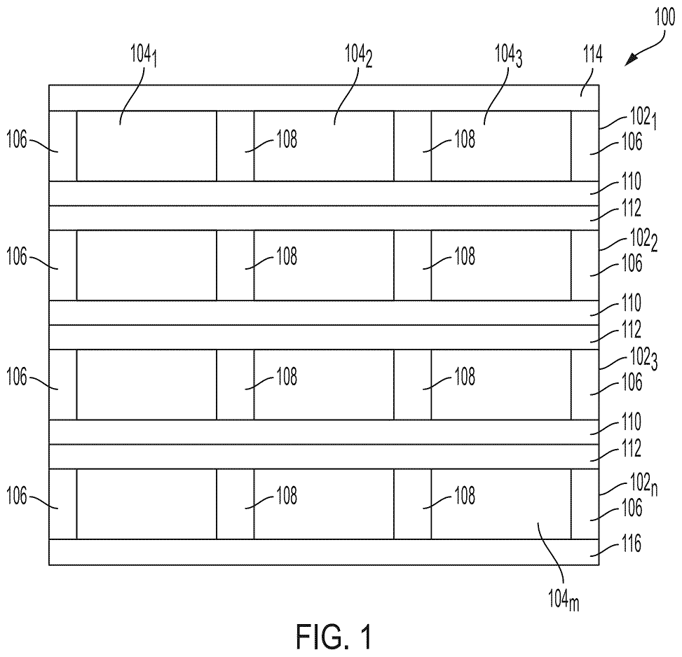

FIG. 1 illustrates a block diagram of a sectional door 100 of the present disclosure. It should be noted that the sectional door 100 in FIG. 1 has been simplified for ease of explanation. The sectional door 100 may include additional features that are not shown. For example the sectional door 100 may include tracks to guide movement of the sectional door, rollers that move the sectional door within the tracks, hinges between sections, a counter balance system (e.g., torsion springs, extension springs, rotating shaft, drums, cables and brackets), an operator, a user interface to control operation of the sectional door, one or more sensors, and the like.

In one embodiment, the sectional door 100 may comprise a plurality of panels or sections 102₁ to 102ₙ (hereinafter also referred to individually as a panel 102 or collectively as panels 102). The panels 102 may be movably connected to one another via mechanical hinges or an interlocking system formed as part of the panels 102. The first panel 102₁ may be the top most panel 102 and the last panel 102ₙ may be the bottom most panel 102.

The panels 102 may include one or more glass panels 104₁ to 104ₘ (hereinafter referred to individually as a glass panel 104 or collectively as glass panels 104). The glass panels 104 may be single pane or double pane windows. The glass panels 104 may be optically clear or may be tinted to reduce glare. Insulated glass uses double panes of glass separated by a vacuum or gas filled space to reduce heat transfer through the panel. “Glass” as used herein may refer to glass, glazing, laminated glass, polycarbonate, polymethylmethacrylate (PMMA), and other similar materials that may be transparent, translucent, tinted, colored, textured, or any other modifications that allow for light to transfer through the thickness thereof.

In one embodiment, the panels 102 and the frame around the glass panels 104 may be formed by a combination of extrusions, such as rails and stiles. The extrusions may be a metal extrusion (e.g., aluminum) or may be a polymer extrusion (e.g., polyethylene resin). For example, the panels 102 and the frames around the glass panels 104 may be formed by a combination of one or more of end stiles 106, center stiles 108, bottom rails 110, and top rails 112. The top most panel 102₁ may include a top most rail 114 and the bottom most panel 102ₙ may include a bottom most rail 116.

As noted above, previous rail and stile designs included an extrusion that provided poor thermal insulation. The extrusion provided a conductive path around insulation in the stiles and rails. As a result, exterior heat could be transferred to the interior of a home or interior heat could be lost to the exterior of the home. The transfer of energy would also create bowing or other distortions in the section, which could lead to damage to the glass panels 104.

The end stiles 106, the center stiles 108, the bottom rails 110, and the top rails 112 of the present disclosure provide de-bridged sections in the extrusion that create a gap and provide a thermal break in the extrusion. The thermal gap prevents heat or energy from conducting through the body of the extrusion. As a result, the end stiles 106, the center stiles 108, the bottom rails 110, and the top rails 112 of the present disclosure provide improved thermal performance.

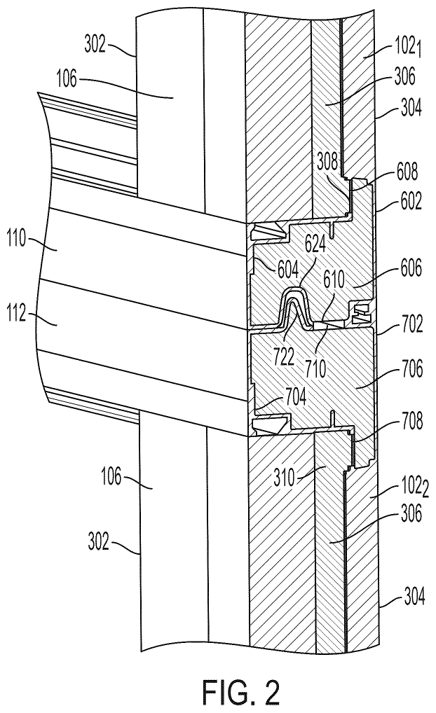

FIG. 2 illustrates a cross-sectional view of an end of the panels 102₁ and 102₂. FIG. 2 illustrates an end stile 106 and the bottom rail 110 of the panel 102₁ and an end stile 106 and the top rail 112 of the panel 102₂. In one embodiment, the bottom rail 110 may include a receiving member 624 and the top rail 112 may include a connecting member 722. The receiving member 624 may run across the entire length of the bottom rail 110. The connecting member 722 may be a protrusion that extends along an entire length of the top rail 112. The connecting member 722 may mate with, or be inserted into, the receiving member 624 to movably couple the panel 102₁ to the panel 102₂. The end stiles 106 may be mechanically coupled (e.g., via screws, fasteners, nuts and bolts, via mechanical coupling features, and the like) to the bottom rail 110 and the top rail 112.

In one embodiment, the end stile 106 may be essentially filled with insulation 306, the bottom rail 110 may be essentially filled with insulation 606, and the top rail 112 may be essentially filed with insulation 706. The insulation 306, 606, and 706 may all be the same type of insulation or may be different types of insulation. In one embodiment, the insulation 306, 606, and 706 may all be a polymeric insulation, such as an expanding polymeric insulation. For example, the insulation 306, 606, and 706 may each be a polyurethane insulation.

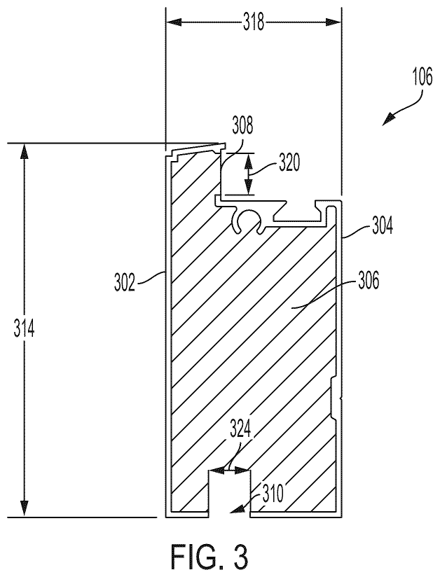

As shown by FIG. 2, the end stile 106, the bottom rail 110, and the top rail 112 may each have a portion of the extrusion removed to de-bridge the extrusion into separate sides. For example, an extrusion of the end stile 106 may be initially formed as a single unitary piece of metal (e.g., aluminum). The interior volume of the extrusion may be filled with the insulation 306. After the insulation 306 is present in the interior volume of the extrusion, the end stile 106 may have a gap 308 (hidden in FIG. 2, but shown in FIG. 3) and a gap 310 that results when the portion is removed to create a first side 302 and a second side 304. The first side 302 and the second side 304 may be separated from one another by a distance (e.g., a gap). In other words, the first side 302 and the second side 304 do not touch or come into contact with one another and are held in proximity by the insulation 306.

The insulation 306 may set a distance between the first side 302 and the second side 304. In other words, the insulation 306 may define the width of the gaps 308 and 310 that are formed in the extrusion. In addition, the insulation 306 may provide rigidity for the structure that may otherwise be lost when the portions of the extrusion are removed to form the gaps 308 and 310.

The bottom rail 110 may have a gap 608 and 610 formed when the portion is removed from a single unitary piece of extruded metal to create a separate first side 602 and a second side 604. In other words, the first side 602 and the second side 604 do not touch or come into contact with one another and are held in proximity by the insulation 606.

The top rail 112 may have a gap 708 and 710 that results when the portion is removed from a single unitary piece of extruded metal to create a separate first side 702 and a second side 704. In other words, the first side 702 and the second side 704 do not touch or come into contact with one another and are held in proximity by the insulation 706.

In addition, the portions 310, 608, 610, 708, and 710 that are removed are strategically located in parts of the extrusion that are not visible when the sectional door 100 is in a closed position. As can be seen in FIG. 2, the gaps 310, 608, 610, 708, and 710 all face an interior portion of the end stile 106, the bottom rail 110, and the top rail 112. Thus, exposed insulation 306, 606, and 706 may not be visible through the gaps 310, 608, 610, 708, and 710.

In some embodiments, a non-conductive strip may be added over the gaps 310, 608, 610, 708, and 710 to hide the exposed insulation 306, 606, and 706. In some embodiments, a non-conductive strip may be added over the portions 610 and 710 only such that exposed insulation 606 and 706 is not visible as the panel 102₁ separates from the panel 102₂ while the sectional door 100 is opening.

FIG. 3 illustrates a cross-sectional view of the end stile 106. FIG. 3 illustrates the insulation 306 essentially filling an interior volume between the first side 302 and the second side 304. FIG. 3 illustrates the gap 308 and the gap 310 that results when the portions are removed from the extrusion of the end stile 106.

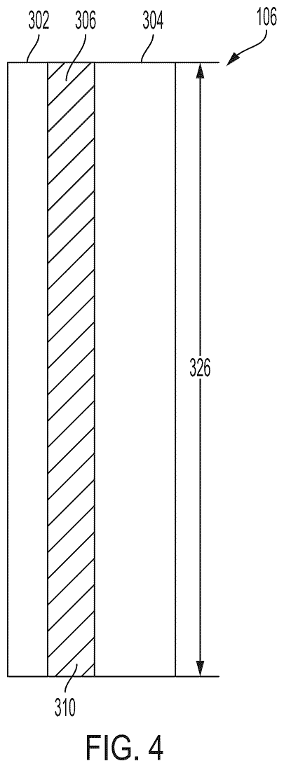

In one embodiment, the gap 308 and the gap 310 that results when the portions are removed may travel the entire length of the end stile 106. FIG. 4 illustrates a side view of the end stile 106. As can be seen in FIG. 4, the gap 310 travels the entire length 326 of the end stile 106. As a result, the first side 302 does not contact the second side 304 and a gap 310 separates the first side 302 and the second side 304.

Referring back to FIG. 3, the end stile 106 may have a width 314 and a depth 318. For example, the width 314 of the end stile 106 may be approximately 4.5 inches and the depth 318 of the end stile 106 may be approximately 2.13 inches.

In one embodiment, the gaps 308 and 310 may be strategically placed to maintain an aesthetic design and maximize thermal performance. In one embodiment, a width of the gaps 308 and 310 that are removed may be selected to maintain a structural integrity of the end stile 106, while maximizing the thermal performance of the end stile 106. In one embodiment, the width is between 0.3 inches to 0.7 inches. In one embodiment, the width is approximately 0.5 inches.

In addition, the gap 308 and the gap 310 may be located on the extrusion opposite one another and hidden from view when the sectional door 100 is in a closed position. For example, the gap 308 may be located on a first section on a first side of the extrusion. The gap 310 may be located on a second section on a second side of the extrusion. The first side and the second side may be opposite one another. In one embodiment, the first side where the gap 308 may be located may be perpendicular to the second side where the gap 310 is located. In other words, a plane of the gap 308 may be perpendicular to a plane of the gap 310.

To illustrate, a plane of the gap 308 may be represented by an arrow 320. A plane of the gap 310 may be represented by an arrow 324. If the arrow 320 is extended to intersect the arrow 324, the arrow 320 would intersect the arrow 324 at 90 degrees.

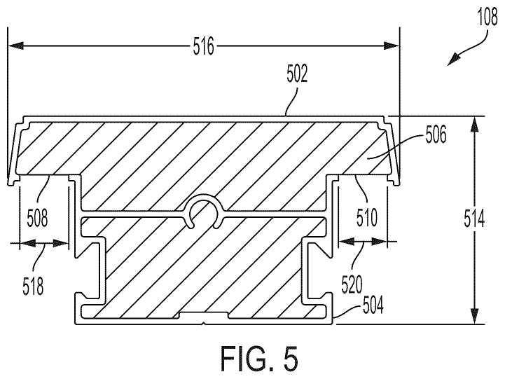

FIG. 5 illustrates a cross-sectional view of the center stile 108. The center stile 108 may have an overall width 516 and a depth 514. In one embodiment, the overall width 516 may be approximately 4 inches and the depth 514 may be approximately 2.125 inches.

The center stile 108 may include a first side 502 and a second side 504. An interior volume formed between the first side 502 and the second side 504 may be essentially filled with insulation 506.

Similar to the end stile 106, the bottom rail 110, and the top rail 112, the first side 502 and the second side 504 may be formed by a gap 508 and a gap 510 that results when a portion is removed from a single unitary extrusion of the center stile 108. The gaps 508 and 510 may travel the entire length of the center stile 108 such that the first side 502 and the second side 504 do not contact one another.

In one embodiment, the gaps 508 and 510 may be strategically located to maintain an aesthetic design and maximize thermal performance. In one embodiment, a width of the gaps 508 and 510 that result when portions are removed may be selected to maintain a structural integrity of the center stile 108, while maximizing the thermal performance of the center stile 108. In one embodiment, the width is between 0.3 inches to 0.7 inches. In one embodiment, the width is approximately 0.5 inches.

In addition, the gap 508 and the gap 510 may be located on the extrusion opposite one another and hidden from view when the sectional door 100 is in a closed position. For example, the gap 508 may be located on a first section on a first side of the extrusion. The gap 510 may be located on a second section on a second side of the extrusion. The first side and the second side may be opposite one another. In one embodiment, the first side where the gap 508 is located may be parallel to the second side where the gap 510 is located. In other words, a plane of the gap 508 may be parallel to a plane of the gap 510.

To illustrate, a plane of the gap 508 may be represented by an arrow 518. A plane of the gap 510 may be represented by an arrow 520. Then arrows 518 and 520 are parallel to one another.

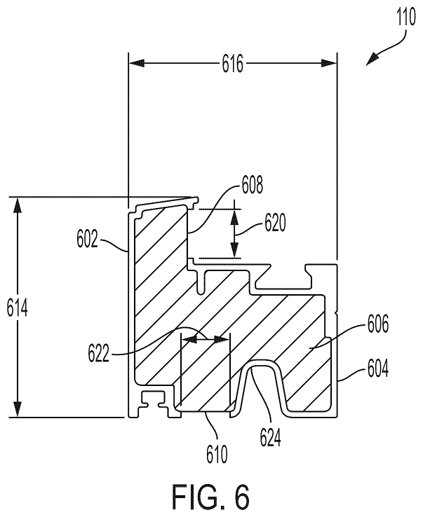

FIG. 6 illustrates a cross-sectional view of the bottom rail 110. FIG. 6 illustrates the insulation 606 essentially filling an interior volume between the first side 602 and the second side 604. FIG. 6 illustrates the gap 608 and the gap 610 that result when portions are removed from the extrusion of the bottom rail 110.

In one embodiment, the gap 608 and the gap 610 that result when portions are removed may travel the entire length of the bottom rail 110. As a result, the first side 602 does not contact the second side 604 and the gaps 608 and 610 are formed between the first side 602 and the second side 604.

In one embodiment, the gaps 608 and 610 may be strategically created to maintain an aesthetic design and maximize thermal performance. In one embodiment, a width of the gaps 608 and 610 may be selected to maintain a structural integrity of the bottom rail 110, while maximizing the thermal performance of the bottom rail 110. In one embodiment, the width is between 0.3 inches to 0.7 inches. In one embodiment, the width is approximately 0.5 inches.

In addition, the gap 608 and the gap 610 may be located on the extrusion opposite one another and hidden from view when the sectional door 100 is in a closed position. For example, the gap 608 may be located on a first section on a first side of the extrusion. The gap 610 may be located on a second section on a second side of the extrusion. The first side and the second side may be opposite one another. In one embodiment, the first side where the gap 608 is located may be perpendicular to the second side where the gap 610 is located. In other words, a plane of the gap 608 may be perpendicular to a plane of the gap 610.

To illustrate, a plane of the gap 608 may be represented by an arrow 620. A plane of the gap 610 may be represented by an arrow 622. If the arrow 620 is extended to intersect the arrow 622, the arrow 620 would intersect the arrow 622 at 90 degrees.

In one embodiment, the bottom rail 110 may have a width 616 and a depth 614. For example, the width 616 of the bottom rail 110 may be approximately 2.13 inches and the depth 614 of the bottom rail 110 may be approximately 2.25 inches.

FIG. 6 also illustrates the receiving member 624. The receiving member 624 may be a depression formed along a side of the bottom rail 110. The receiving member 624 may have a shape that allows some angular rotation between adjacent panels 102 while keeping the adjacent panels 102 interlocked or connected. In one embodiment, the receiving member 624 may have a parabolic cross-sectional shape, a conic cross-sectional shape, a “U” cross-sectional shape, or a “V” cross-sectional shape. However, it should be noted that the receiving member 624 may have any shape that allows angular rotation while keeping adjacent panels 102 interlocked or connected.

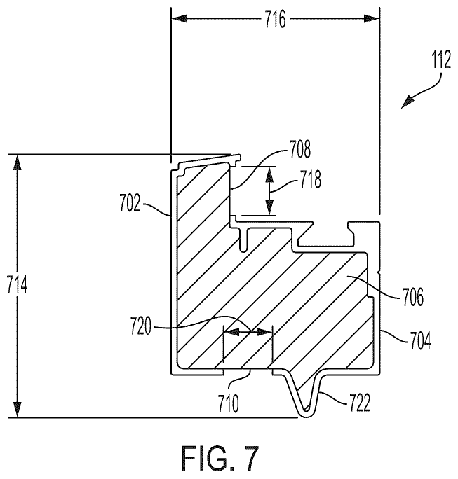

FIG. 7 illustrates a cross-sectional view of the top rail 112. FIG. 7 illustrates the insulation 706 essentially filling an interior volume between the first side 702 and the second side 704. FIG. 7 illustrates the gap 708 and the gap 710 that result when portions are removed from the extrusion of the top rail 112.

In one embodiment, the gap 708 and the gap 710 that result when portions are removed may travel the entire length of the top rail 112. As a result, the first side 702 does not contact the second side 704 and the gaps 708 and 710 are formed between the first side 702 and the second side 704.

In one embodiment, the gaps 708 and 710 may be strategically located to maintain an aesthetic design and maximize thermal performance. In one embodiment, a width of the gaps 708 and 710 may be selected to maintain a structural integrity of the top rail 112, while maximizing the thermal performance of the top rail 112. In one embodiment, the width is between 0.3 inches to 0.7 inches. In one embodiment, the width is approximately 0.5 inches.

In addition, the gap 708 and the gap 710 may be located on the extrusion opposite one another and hidden from view when the sectional door 100 is in a closed position. For example, the gap 708 may result when portions are removed from a first section on a first side of the extrusion. The gap 710 may result when portions are removed from a second section on a second side of the extrusion. The first side and the second side may be opposite one another. In one embodiment, the first side where the gap 708 may be perpendicular to the second side where the gap 710 is located. In other words, a plane of the gap 708 may be perpendicular to a plane of the gap 710.

To illustrate, a plane of the gap 708 may be represented by an arrow 718. A plane of the gap 710 may be represented by an arrow 720. If the arrow 718 is extended to intersect the arrow 720, the arrow 718 would intersect the arrow 720 at 90 degrees.

In one embodiment, the top rail 112 may have a width 716 and a depth 714. For example, the width 716 of the top rail 112 may be approximately 2.13 inches and the depth 714 of the top rail 112 may be approximately 2.69 inches.

FIG. 7 also illustrates the connection member 722. The receiving connection member 722 may be a protrusion formed along a side of the top rail 112. The connection member 722 corresponds to the shape of the receiving member 624 of the bottom rail 110.

The connection member 722 may have a shape that allows some angular rotation between adjacent panels 102 while keeping the adjacent panels 102 interlocked or connected. In one embodiment, the receiving member 624 may have a parabolic cross-sectional shape, a conic cross-sectional shape, a “U” cross-sectional shape, or a “V” cross-sectional shape. However, it should be noted that the connection member 722 may have any shape that allows angular rotation while keeping adjacent panels 102 interlocked or connected.

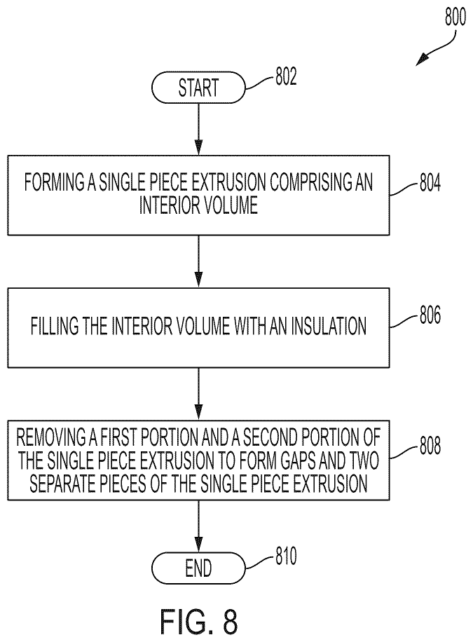

FIG. 8 a flow chart of a method 800 for fabricating a de-bridged extrusion for a panel of a sectional door of the present disclosure. The method 800 may be performed by various automated tools under the control of a controller or processor.

The method 800 begins at block 802. At block 804, the method 800 forms a single piece extrusion comprising an interior volume. For example, the single piece extrusion may be a metal extrusion (e.g., an aluminum extrusion) or a polymer extrusion (e.g., polyethylene resin). The single piece extrusion may be formed with a hollow interior in the shape of the end stile 106, the center stile 108, the bottom rail 110, or the top rail 114. The single piece extrusion may be cut to a desired length for the end stile 106, the center stile 108, the bottom rail 110, or the top rail 114.

At block 806, the method 800 fills the interior volume with an insulation. For example, the insulation may be injected into the interior volume of the single piece extrusion as a liquid. As the insulation is cured, the insulation may expand to essentially fill the interior volume of the single piece extrusion.

In one embodiment, the insulation may be a polymeric insulation, such as an expanding polymeric insulation. For example, the insulation may be a polyurethane insulation.

At block 808, the method 800 removes a first portion and a second portion of the single piece extrusion to form gaps and two separate pieces of the single piece extrusion. In one embodiment, the first portion may be removed from a first section on a first side of the extrusion. The second portion may be removed from a second section on a second side of the extrusion that is opposite the first side.

In one embodiment, the first portion and the second portion may be removed to form gaps on a plane that are parallel to each other. In one embodiment, the first portion and the second portion may be removed to form gaps on a plane that are perpendicular to one another.

In one embodiment, the gaps that are formed may have the same width or may have a different width. In one embodiment, the width of the first portion and the second portion may be approximately 0.4 inches to 0.6 inches. In one embodiment, the width of the first portion and the second portion may be approximately 0.5 inches.

The first portion and the second portion may be removed along the entire length of the extrusion to form the first side and the second side. The first side and the second side may be held in proximity by the insulation. At block 810, the method 800 ends.

Thus, the present disclosure provides de-bridged extrusions for panels of a sectional door. The de-bridged extrusions provide improved thermal performance for the sectional door. The portions of the extrusion that are removed to form the de-bridged extrusions may be located on portions of the extrusion that are not visible when the sectional door is in a closed position.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A de-bridged extrusion for a panel of a sectional door, comprising:
a first side;
a second side; and
an insulation essentially filling a volume between the first side and the second side, wherein the first side and the second side are derived from a single piece of extrusion and a portion of the single piece of extrusion is removed to create a gap between the first side and the second side.

2. The de-bridged extrusion of claim 1, wherein the single piece of extrusion comprises a metal or a polymer extrusion.

3. The de-bridged extrusion of claim 2, wherein the single piece of extrusion that comprises the metal comprises an aluminum extrusion.

4. The de-bridged extrusion of claim 1, wherein the gap is located on the single piece of extrusion that is not visible when the de-bridged extrusion is assembled as part of the panel.

5. The de-bridged extrusion of claim 1, wherein the gap comprises:
a first gap on the first side of the de-bridged extrusion; and
a second gap on the second side of the de-bridged extrusion, wherein the second side is opposite the first side.

6. The de-bridged extrusion of claim 5, wherein the first gap and the second gap are identical and located on a plane that is parallel to each other.

7. The de-bridged extrusion of claim 5, wherein the first gap and the second gap are identical and located on a plane that is perpendicular to each other.

8. The de-bridged extrusion of claim 1, wherein the gap comprises a width of approximately 0.4 inches to 0.6 inches along an entire length of the single piece of extrusion.

9. The de-bridged extrusion of claim 8, wherein the width comprises 0.5 inches.

10. The de-bridged extrusion of claim 1, wherein the insulation comprises polyurethane.

11. A method for fabricating a de-bridged extrusion for a panel of a sectional door, comprising:
forming a single piece metal extrusion comprising an interior volume;
filling the interior volume with an insulation; and
removing a first portion and a second portion of the single piece metal extrusion to form gaps and two separate pieces of the single piece metal extrusion.

12. The method of claim 11, wherein the gaps have an identical width and are located along an entire length of the single piece metal extrusion.

13. The method of claim 12, wherein the identical width comprises approximately 0.4 to 0.6 inches.

14. The method of claim 13, wherein the identical width comprises 0.5 inches.

15. The method of claim 11, wherein the gaps are located on opposite sides on a plane that is parallel to each other.

16. The method of claim 11, wherein the gaps are located on opposite sides on a plane that is perpendicular to each other.

17. A sectional door, comprising:
a plurality of panels, wherein each panel of the plurality of panels comprises a combination of one or more of: an end stile, a bottom rail, a top rail, or a center stile, wherein each one of the end stile, the bottom rail, the top rail, and the center stile, comprises:
a first side;
a second side; and
an insulating foam essentially filling a volume between the first side and the second side, wherein the first side and the second side are derived from a single piece of extrusion and a first portion and a second portion on opposite sides of the single piece of extrusion are removed to create a gap between the first side and the second side.

18. The sectional door of claim 17, wherein the gap comprises approximately 0.5 inches.

19. The sectional door of claim 17, wherein the gap comprises a first gap and a second gap that are located on a plane that is parallel to each other for the center stile.

20. The sectional door of claim 17, wherein the gap comprises a first gap and a second gap that are located on a plane that is perpendicular to each other for the end stile, the bottom rail, and the top rail.
